(19) United States
(12) Patent Application Publication
(10) Pub. No.: US 2023/0127625 A1
(43) Pub. Date: Apr. 27, 2023

(54) ANONYMIZATION SYSTEM AND METHOD

(71) Applicant: GO INCOG, LLC, Denver, CO (US)

(72) Inventors: Debora A. Miller, Denver, CO (US); Jermaine Johnston, Denver, CO (US)

(21) Appl. No.: 17/970,749

(22) Filed: Oct. 21, 2022

Related U.S. Application Data
(60) Provisional application No. 63/271,490, filed on Oct. 25, 2021.

(51) Int. Cl. H04L 9/40

(52) U.S. Cl. CPC H04L 63/0421; H04L 63/0442

(57) ABSTRACT

An anonymization system (100) for anonymizing data within an anonymization receiver (110) for use by a first user (112) and a second user (114). The anonymization system (100) includes an anonymizer (102) and a database (104). The database (104) that is configured to store at least one of (i) a first data that corresponds to the first user (112), and (ii) a second data that corresponds to the second user (114). The anonymizer (102) anonymizes at least one of the first data and the second data. The anonymizer (102) is configured to transfer anonymized data to the anonymization receiver (110). The anonymizer (102) is configured to generate an anonymizing identifier that is based on at least one of the first data and the second data. The anonymizer (102) is configured to generate a token that represents the anonymizing identifier.

### RELATED APPLICATION

This Application is related to and claims priority on U.S. Provisional Patent Application Ser. No. 63/271,490 filed on Oct. 25, 2021, entitled “ANONYMIZATION SYSTEM AND METHOD.” To the extent permissible, the contents of U.S. Provisional Application Ser. No. 63/271,490 are incorporated in their entirety herein by reference.

### BACKGROUND

In contracts, revealing the identity of some or all contract parties might expose the parties to bias and/or liability. Sometimes, the parties to an agreement are hidden to overcome this problem. Anonymization prevents discrimination toward (or against) a person, decreases the chance of liability based on unfair business practices, and can benefit all parties.

Real estate is an example of a field where anonymized contracts could be implemented. Regarding real estate, the primary approach has been educating real estate brokers/agents, home buyers, and sellers. Educating the home buyers and sellers has primarily fallen into the hands of the real estate brokers/agents. Legal contracts are typically legally enforceable agreements between two or more parties. For multiple reasons, it can be beneficial for one or more of these parties to stay anonymous.

The Fair Housing Act prohibits discrimination in home sales, financing, and rentals against protected classes. Currently, violations of the fair housing act can result in civil penalties from $21,410 up to $107,050. For example, any real estate offer that might be withdrawn due to a potential bias towards (or against) protected classes (race, gender, political affiliation, sexual orientation, age, etc.) can expose involved parties to legal risks.

### SUMMARY

The present invention is directed toward an anonymization system for anonymizing data within an anonymization receiver for use by a first user and a second user. In various embodiments, the anonymization system includes a database and an anonymizer. The database can be configured to store at least one of (i) a first data that corresponds to the first user, and (ii) a second data that corresponds to the second user. The anonymizer can anonymize at least one of the first user data and the second user data. The anonymizer can be configured to transfer anonymized data to the anonymization receiver.

In some embodiments, the anonymized data includes an identity of the first user.

In certain embodiments, the anonymized data includes an identity of the second user.

In various embodiments, the anonymizer is configured to generate an anonymizing identifier that is based on at least one of the first data and the second data.

In some embodiments, the anonymizer is configured to generate a token that represents the anonymizing identifier.

In certain embodiments, the anonymizer is configured to encrypt at least one of the first data and the second data.

In various embodiments, the anonymizer is configured to encrypt using an AES algorithm.

In some embodiments, the anonymizer is configured to store at least one of an encryption key and a decryption key on the database.

In certain embodiments, the anonymizer is configured to de-anonymize the anonymized data.

In various embodiments, the anonymizer is configured to use artificial intelligence to automatically detect and anonymize the anonymization receiver.

The present invention is further directed toward a method for anonymizing data within an anonymization receiver for use by a first user and a second user. In various embodiments, the method can include the steps of storing at least one of (i) a first data that corresponds to the first user, and (ii) a second data that corresponds to the second user in a database, anonymizing at least one of the first user data and the second user data with an anonymizer, and transferring anonymized data to the anonymization receiver.

In some embodiments, the method further comprises the step of generating an anonymizing identifier that is based on at least one of the first data and the second data with the anonymizer.

In certain embodiments, the method further comprises the step of generating a token that represents the anonymizing identifier with the anonymizer.

In various embodiments, the method further comprises the step of hashing at least one of the first data and the second data with the anonymizer.

In some embodiments, the method further comprises the step of encrypting at least one of the first data and the second data with the anonymizer.

In certain embodiments, the step of encrypting is completed using an AES algorithm.

In various embodiments, the method further comprises the step of storing at least one of an encryption key and a decryption key on the database.

In some embodiments, the anonymizer is configured to de-anonymize the anonymized data.

In certain embodiments, the database is configured to allow access to data by users based on a plurality of permission settings.

The present invention is also directed toward an anonymization system for anonymizing data within an anonymization receiver for use by a first user and a second user. In various embodiments, the anonymization system includes a database and an anonymizer. The database is configured to store at least one of (i) a first data that corresponds to the first user, and (ii) a second data that corresponds to the second user. The anonymizer anonymizes at least one of the first user data and the second user data. The anonymizer is configured to transfer anonymized data to the anonymization receiver. The anonymizer is configured to (i) generate an anonymizing identifier that is based on at least one of the first data and the second data, (ii) generate a token that represents the anonymizing identifier, (iii) encrypt at least one of the first data and the second data, (iv) de-anonymize the anonymized user data, and (v) use artificial intelligence to automatically detect and anonymize the anonymization receiver.

This summary is an overview of some of the teachings of the present invention and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a block diagram depicting one embodiment of an anonymization system having features of the present invention;

FIG. 2 is a flow chart depicting one embodiment of a method for anonymizing data having steps of the present invention; and

FIG. 3 is an illustration depicting yet another embodiment of the anonymization system having various elements that interact and perform steps in yet another method for anonymizing data.

While embodiments of the present invention are susceptible to various modifications and alternative forms, specifics thereof, have been shown through examples and drawings and are described in detail herein. It is understood, however, that the scope herein is not limited to the embodiments described. On the contrary, the intention is to cover modifications, equivalents, and alternatives falling within the spirit and scope herein.

### DESCRIPTION

Embodiments of the present invention are described herein in the context of anonymization systems and methods. In particular, the present technology can allow users to protect and/or anonymize certain identifiable information in anonymization receiver(s). As used herein, “an anonymization receiver” is understood to mean any location of identifiable information that is able to substitute the identifiable information with anonymized information. Non-exclusive, non-limiting examples of anonymization receivers include documents, contracts, websites, healthcare records, government records, and/or any suitable anonymization receiver that may benefit from anonymized information in a public or private setting.

Those of ordinary skill in the art will realize that the following detailed description of the present invention is illustrative only and is not intended to be in any way limiting. Other embodiments of the present invention will readily suggest themselves to such skilled people having the benefit of this disclosure. Reference will now be made in detail to implementations of the present invention, as illustrated in the accompanying drawings.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it is appreciated that such a development effort might be complex and time-consuming but would nevertheless be a routine undertaking of engineering for those of ordinary skill in the art having the benefit of this disclosure.

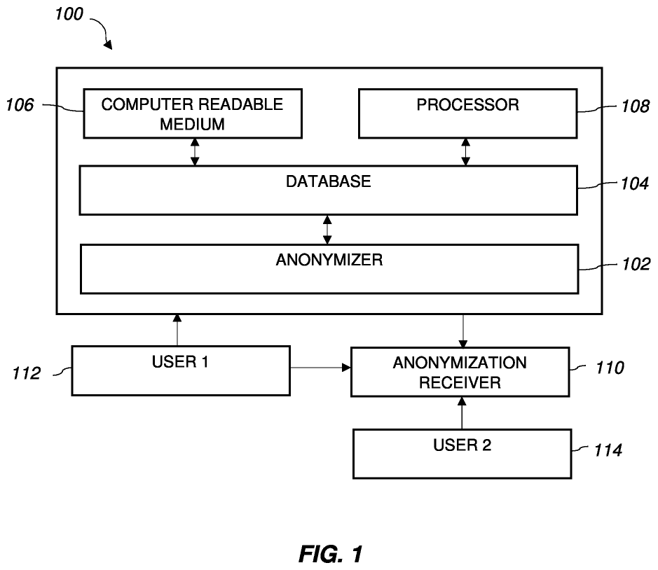

FIG. 1 is a block diagram depicting one embodiment of an anonymization system 100. The anonymization system 100 is suitable for the generation of anonymized data in which an anonymized identifier represents some or all user data. The anonymization system 100 can include encryption and tokenization of data (such as the anonymized identifier). The anonymized identifier is kept private to all users and is only accessible to the system administrator. Users can selectively reveal their anonymized identifier at any time to any of the involved users through the system.

In some embodiments, the anonymization system 100 can be tailored to contracts. The anonymization system 100 can include an all-in-one integration of contracts. For example, the user can provide (i) the contracts, (ii) an external legal document database that can be integrated, and/or (iii) documents uploaded to the system by the parties of the contract. The system can implement artificial intelligence (including machine learning and deep learning) to anonymize portions of pre-analyzed contracts automatically. The system can also interpret and/or evaluate specific contract terms and clauses using artificial intelligence.

The anonymization system 100 can vary depending on the design requirements of the anonymization system 100. It is understood that the anonymization system 100 can include other systems, subsystems, components, and elements than those specifically shown and described herein. Additionally, or alternatively, the anonymization system 100 can omit one or more of the systems, subsystems, and elements that are specifically shown and described herein. In the embodiment illustrated in FIG. 1, the anonymization system 100 can include an anonymizer 102, a database 104, a non-transitory computer-readable medium 106, a processor 108, and an anonymization receiver 110. The anonymization system 100 can be usable by at least a first user 112 and a second user 114, or any suitable number of users.

The anonymizer 102 anonymizes data on the database 104 within the anonymization system 100 and transmits the anonymized data to the anonymization receiver 110. The anonymized data can include first data pertaining to the first user 112 (including the identity of the first user 112) and second data pertaining to the second user 114 (including the identity of the second user 114).

The anonymizer 102 can generate an anonymizing identifier based on any potentially identifiable information and/or data. For example, in some embodiments, the anonymizer 102 is configured to generate an anonymizing identifier that is based on at least one of the first data and the second data. For example, the first data and the second data can include identifying information of a user, including, but not limited to: (i) a first and/or last name, (ii) a date of birth, and/or (iii) social security numbers, as non-limiting, non-exclusive examples.

The anonymizer 102 can generate a token that represents the anonymizing identifier of a user (e.g., the first user 112). The anonymizer 102 can recreate the token based on the user's identifying information. In some embodiments, the anonymizer 102 can also de-anonymize the anonymized data. The anonymizer 102 can cooperate with the artificial intelligence of the anonymization system 100 to automatically detect and anonymize the anonymization receiver 110.

The anonymizer 102 can encrypt data within the anonymization system 100 and the database 104. The anonymizer 102 can encrypt at least one of the first data and the second data. The anonymizer 102 can encrypt using an AES algorithm or any suitable encryption function known in the art. The anonymizer 102 can store at least one of an encryption key and a decryption key on the database 104.

The anonymizer 102 can vary depending on the design requirements of the anonymization system 100. It is understood that the anonymizer 102 can include other systems, subsystems, components, and elements than those specifically shown and/or described herein. Additionally, or alternatively, the anonymizer 102 can omit one or more of the systems, subsystems, and elements that are specifically shown and/or described herein.

The database 104 can store at least one of the first data that pertains to the first user 112 and the second data that pertains to the second user 114. The database 104 includes data and/or a dataset that can be processed and/or accessed by the anonymizer 102 and/or the processor 108. The database 104 can allow access to users based on a plurality of permission settings of the database 104. In one example, under a first permission setting, the first user 112 has access to the first data and a first anonymized data (e.g., the first data of the first user 112 that has been anonymized by the anonymizer 102). In another example, under a second permission setting, the second user 114 only has access to the first anonymized data. In some embodiments, the first user 112 is a real estate buyer, and the second user 114 is a real estate seller.

The database 104 can vary depending on the design requirements of the anonymization system 100 and/or the anonymizer 102. It is understood that the database 104 can include additional systems, subsystems, components, and elements than those specifically shown and/or described herein. Additionally, or alternatively, the database 104 can omit one or more of the systems, subsystems, and elements that are specifically shown and/or described herein.

The non-transitory computer-readable medium 106 can store computer program instructions. The non-transitory computer-readable medium 106 can vary depending on the design requirements of the anonymization system 100, the anonymizer 102, and/or the database 104, the processor 108, and/or the anonymization receiver 110. It is understood that the non-transitory computer-readable medium 106 can include additional systems, subsystems, components, and elements than those specifically shown and/or described herein. Additionally, or alternatively, the non-transitory computer-readable medium 106 can omit one or more of the systems, subsystems, and elements that are specifically shown and/or described herein.

The non-transitory computer-readable medium 106 can be a tangible computer-readable carrier, such as a magnetic or optical memory or a magnetic or optical disk, as non-exclusive, non-limiting examples. The database 104 can be stored on the non-transitory computer-readable medium 106. The non-transitory computer-readable medium 106 can include any number of computer units, processors, systems, devices, and/or components necessary to perform the functions of the anonymization system 100.

The processor 108 can process a number of operations, including executing code. The processor 108 can control, facilitate, and/or administrate all of the functions within the anonymization system 100. The processor 108 can vary depending on the design requirements of the anonymization system 100. It is understood that processor 108 can include additional systems, subsystems, components, and elements than those specifically shown and/or described herein. Additionally, or alternatively, the processor 108 can omit one or more of the systems, subsystems, and elements that are specifically shown and/or described herein. One or more processors 108 can be used in the communication system. The processor 108 can work in cooperation with the non-transitory computer-readable medium 106 to input the database 104 into the anonymization system 100.

The anonymization receiver 110 receives the anonymized data, such as the anonymized identifier, from the database 104. The anonymized identifier can be used as a placeholder in the anonymization receiver 110. The anonymized party can dynamically control the anonymized identifier (e.g., the first user 112). For example, the anonymized identifier within a contract can remain anonymous until the anonymized party agrees to disclose its identity. The non-anonymized party (e.g., the second user 114) cannot use the anonymized identifier to determine the identity of the anonymized party (e.g., the first user) without the explicit permission of the anonymized party.

The anonymization receiver 110 can be accessible to at least the first user 112 and the second user 114. Other data within the anonymization receiver 110 can be actively anonymized by the anonymizer 102. The anonymization receiver 110 can vary. The anonymization receiver 110 can include documents, contracts, websites, healthcare records, government records, and/or any suitable anonymization receiver 110 that may benefit from anonymized information in public, private, and/or legal settings.

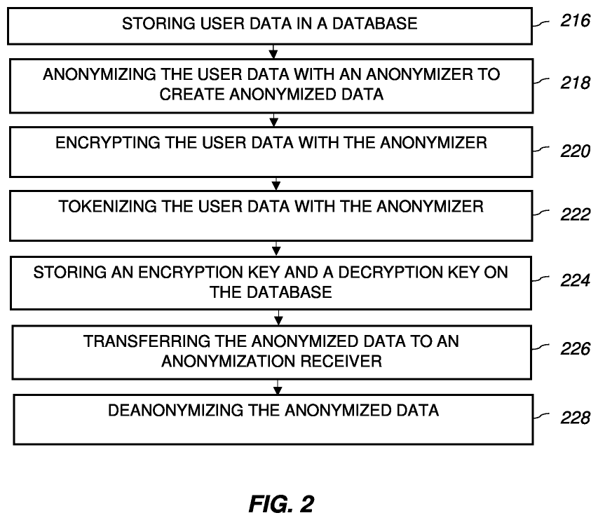

FIG. 2 is a flow chart depicting one embodiment of a method for anonymizing data that can include one or more of the following steps provided herein. It is understood that the method can include additional steps than those specifically shown and/or described herein. Additionally, or alternatively, the method can omit one or more of the steps that are specifically shown and/or described herein. The method for data processing can be implemented on the anonymization system 100 (illustrated in FIG. 1) or other systems and subsystems not specifically shown and/or described herein. It is understood that the method shown and/or described herein can be controlled by the processor 108 (illustrated in FIG. 1) or other components of the anonymization system 100. In other words, the method can be enabled by the anonymization system 100 via the processor 108.

At step 216, user data is stored on the database 104 (illustrated in FIG. 1). The database 104 can store at least one of the first data that corresponds to the first user 112 (illustrated in FIG. 1), and the second data that corresponds to the second user 114 (illustrated in FIG. 1). The database 104 includes data and/or a dataset that can be processed and/or accessed by the anonymizer 102 (illustrated in FIG. 1) and/or the processor 108 (illustrated in FIG. 1).

At step 218, the user data is anonymized with the anonymizer 102 to create anonymized data. The anonymized data can include first data on the first user 112 (including the identity of the first user 112) and second data on the second user 114 (including the identity of the second user 114).

At step 220, the user data is encrypted with the anonymizer 102. The anonymizer 102 can encrypt data within the anonymization system 100 and the database 104. The anonymizer 102 can encrypt at least one of the first data and the second data. The anonymizer 102 can encrypt using an AES algorithm, or any suitable encryption function known in the art.

At step 222, the user data is hashed with the anonymizer 102. The anonymizer 102 can generate a token that represents the anonymizing identifier. The anonymizer 102 can hash via one or more keys, numeric, alphabetical by the first tuple, or any suitable hashing method known in the art.

At step 224, an encryption key and a decryption key are stored on the database 104. The anonymizer 102 can generate the encryption key and the decryption key upon completion of the encryption.

At step 226, the anonymized data is transferred to the anonymization receiver 110. Other data within the anonymization receiver 110 can be actively anonymized by the anonymizer 102. The anonymization receiver 110 can include documents, contracts, websites, healthcare records, government records, and/or any suitable anonymization receiver 110 that may benefit from anonymized information in a public setting, a private setting, and/or a legal setting.

At step 228, the anonymized data is de-anonymized. The first user 112 and/or the second user 114 can de-anonymize the user data at their will. The anonymizer 102 can be utilized to de-anonymize the user data.

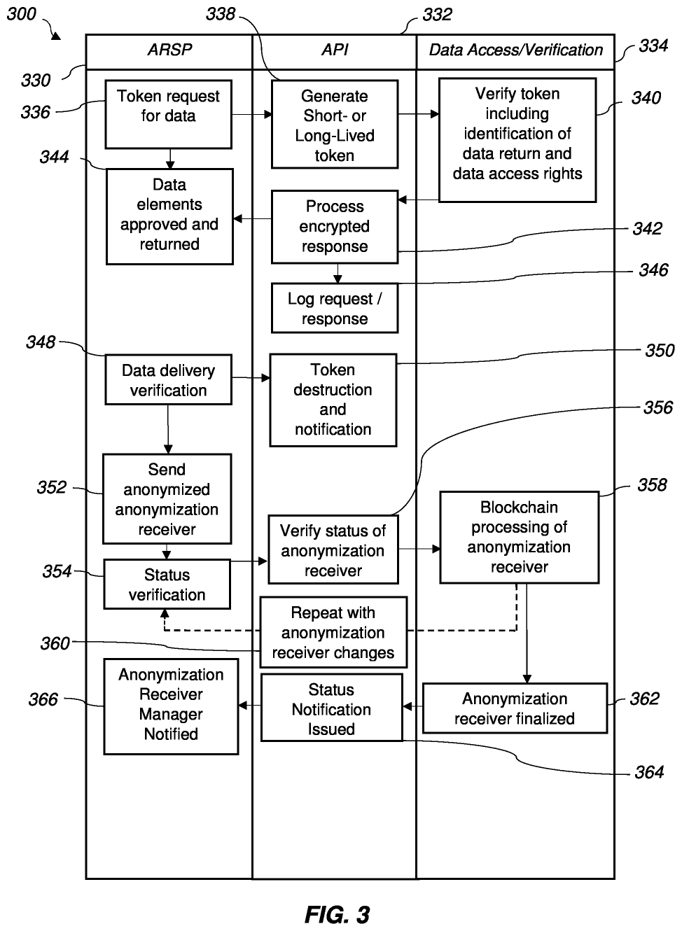

FIG. 3 is an illustration depicting yet another embodiment of the anonymization system 300 having various elements that interact and perform steps in yet another method for anonymizing data. In the embodiment illustrated in FIG. 3, the anonymization system 300 can include an anonymization receiver service provider 330 (shown in FIG. 3 as “ARSP”), an application programming interface 332 (shown in FIG. 3 as “API”), and a data access/verification layer 334.

The anonymization receiver service provider 330 provides services related to the anonymization receiver 110 (illustrated in FIG. 1). For example, the anonymization receiver service provider 330 manages, controls, updates, and/or provides the anonymization receiver 110.

The anonymization receiver service provider 330 can vary depending on the design requirements of the anonymization system 200. It is understood that the anonymization receiver service provider 330 can include additional systems, subsystems, components, and elements than those specifically shown and/or described herein. Additionally, or alternatively, the anonymization receiver service provider 332 can omit one or more of the systems, subsystems, and elements that are specifically shown and/or described herein.

The application programming interface (API) 332 interacts and provides an interface between the anonymization receiver service provider 330 and the data access/verification layer 334. The application programming interface (API) 332 can include a set of functions and procedures that allow the creation of new applications that access the features, data, or applications of the anonymization system 300 and its various subsystems. The application programming interface (API) 332 may also include support for older or legacy APIs for integration with legacy systems. Modern APIs can also be supported within the application programming interface (API) 332 and may include web or HTTPS as non-exclusive, non-limiting examples. The application programming interface (API) 332 can have multiple elements. Alternatively, the application programming interface (API) 332 can be one singular element connected to all the other elements in the anonymization system 300. Still alternatively, the application programming interface (API) 332 can be connected to less than all of the other elements in the anonymization system 300, and the application programming interface (API) 332 may only be connected to one other element. The application programming interface (API) 332 can include other elements, systems, subsystems, functionalities, and modalities not specifically shown and/or described herein.

The data access/verification layer 334 provides functionality and data access to the anonymization receiver service provider 330 and the application programming interface (API) 332.

The data access/verification layer 334 can vary depending on the design requirements of the anonymization system 300. It is understood that the data access/verification layer 334 can include additional systems, subsystems, components, and elements than those specifically shown and/or described herein. Additionally, or alternatively, the data access/verification layer 334 can omit one or more of the systems, subsystems, and elements that are specifically shown and/or described herein.

FIG. 3 also illustrates a flow chart depicting one embodiment of a method for anonymizing data that can include one or more of the following steps provided herein. It is understood that the method can include additional steps than those specifically shown and/or described herein. Additionally, or alternatively, the method can omit one or more of the steps that are specifically shown and/or described herein. The method for data processing can be implemented on the anonymization system 300 or other systems and subsystems not specifically shown and/or described herein. It is understood that the method shown and/or described herein can be controlled by the processor 108 (illustrated in FIG. 1) or other components of the anonymization system 300. In other words, the method can be enabled by the anonymization system 300 via the processor 108.

At step 336, a token is requested by the anonymization receiver service provider 330 for a first user. The requested token can be used for data retrieval and each requested token (whether anonymized or not) is unique. This request for the token can create a ledger item using blockchain technology. The ledger item indicates the origination of the request and the recipient of the request.

At step 338, the application programming interface (API) 332 generates a short-lived or long-lived token for the first user. The token can include the anonymized personal information of the first user. The anonymization system 300 will determine the frequency, lifespan, origin, and/or rules associated with the use of the token. In some embodiments, factors such as Standard Industry Codes (SIC Codes), car buying, mortgages, w-9s, and w-2s, can be used to determine the duration of a token's existence. The token can also be voided once the data has been sent and verified as received by the intended recipient.

At step 340, the token is verified by the data access/verification layer 334. The verification process can include inputs and/or attributes provided by the first user. The data access/verification layer 334 identifies the data return and data access rights included with the token. In some embodiments, the data access/verification layer 334 scrutinizes the token to verify the authorization of data retrieval and access rights.

If the anonymizer submits multiple requests for tokens to be generated for personal information to be provided, the anonymization system will provide a unique time-based token to the appropriate recipient and notify the anonymized party when this data is retrieved. Attempts to pass the token will cause a collapse of the request chain, the token will be invalidated, and the offending party's information will be given to the anonymized party and possibly to fraud-based reporting agencies.

At step 342, the application programming interface (API) 332 processes an encrypted response. Identified data elements are encrypted for transportation of the data to the data requester (e.g., a second user). The data is decrypted when the data is at rest.

At step 344, the application programming interface (API) 332 and/or a plug-in interface approves and returns data elements to the anonymization receiver service provider 330.

At step 346, the application programming interface (API) 332 logs the token request and the encrypted response.

At step 348, the anonymization receiver service provider 330 verifies the delivery of data. The anonymization system 300 ensures delivery of the data via an HTTP response code of 200. If the HTTP response code of 200 is not received, the anonymization system 300 will queue the response for a configurable amount of retry attempts.

At step 350, the application programming interface (API) 332 destroys the token, and one or more users of the anonymization system 300 are notified. In some embodiments, the token used for the original request is destroyed, and the token is unable to be used again in the short-lived token process. In various embodiments, the long-lived token can be reused throughout the process for the originally intended use.

At step 352, the anonymization receiver service provider 330 sends an anonymized anonymization receiver to one or more users. The anonymization receiver service provider 330 can cooperate with the application programming interface (API) 332 to integrate the functionality of the anonymization receiver within the anonymization system 300.

At steps 354 and 356, the anonymization receiver service provider 330 sends the status of the anonymization receiver to the application programming interface (API) 332. In certain embodiments, the status of the anonymization receiver can be sent using SignaIR® technology for real-time updates on the anonymization receiver, increasing the efficiency and processing speed of the anonymization system 300.

At step 358, the data access/verification layer 334 includes a digital blockchain ledger and blockchain processing to track and account for changes to the anonymization receiver. In some embodiments where the anonymization receiver is a land sale contract, the digital blockchain technology will track/ledger acceptances, rejections, counteroffers, negotiations, and/or contingencies.

At step 360, steps 354 through 358 are repeated as changes are made to the anonymization receiver. As soon as the anonymization receiver is finalized, the method proceeds to step 362.

At step 362, when the anonymization receiver is finalized, the data access/verification layer 334 tracks all decisions on the anonymization receiver in an auditable format to recreate the series of events associated with the anonymization receiver.

At step 364, the application programming interface (API) 332 and/or the anonymization system 300 will notify one or more users of the status of the anonymization receiver and any subsequent requests for additional information and/or authorizations. The notification can be sent via SMS, text message, and/or any suitable communication method.

At step 366, the manager of the anonymization receiver service provider 330 is notified of the status of the anonymization receiver. In certain embodiments, the manager is notified via SignaIR® of the status of the anonymization receiver.

The systems and methods described herein can improve the anonymization of data in anonymization receivers 110, such as sale contracts. For example, the systems and methods described herein allow (i) a buyer to protect their identity and remain anonymous in contract negotiations and (ii) a seller to evaluate offers based on the offer's merit. In particular, the systems and methods herein enable the creation of contracts in which an anonymized identifier represents some or all parties. The anonymized identifier is kept private to all parties and is only accessible to the system administrator. Parties can selectively reveal their anonymized identifier at any time to any of the involved parties through the system.

Older anonymization methods take a simple approach of removing the first and last name within a specified contract. The older approach to this is to encrypt the data at rest within the database structure. This is no longer efficient and reliable as the data is primarily in motion in modern anonymization systems.

As provided in the various embodiments shown and described herein, the data is anonymizable at rest and in transit. The anonymization systems and methods provided herein leave various other personally identifiable information available to perform a reverse search of who the individual(s) may be. This anonymization system described herein masks and anonymizes an individual's information to where it becomes less traceable and more secure. The tokens used by the system are constantly rotating, making it increasingly difficult for a person to be identified with the controls put in place by the anonymization infrastructure.

In some embodiments, the systems and methods herein enable the all-in-one integration of contracts. For example, the parties can provide the contracts, or an external legal document database can be integrated, or documents uploaded to the system by the parties of the contract. The system can implement artificial intelligence to automatically anonymize portions of pre-analyzed contracts. In certain embodiments, the systems and methods extend and provide a process for users to evaluate a contract for specific terms. This is useful in cases where multiple offers have been submitted to purchase an item, such as real estate.

Systems, methods, and computer program products are provided. In the detailed description herein, references to “various embodiments,” “one embodiment,” “an embodiment,” “an example embodiment,” “certain embodiments,” “some embodiments,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described. After reading the description, it will be apparent to one skilled in the relevant art(s) how to implement the disclosure in alternative embodiments.

In various embodiments, the methods described herein are implemented using the various particular machines described herein. The methods described herein can be implemented using the below particular machines, and those hereinafter developed, in any suitable combination, as would be appreciated immediately by one skilled in the art. Further, as is unambiguous from this disclosure, the methods described herein can result in various transformations of specific articles.

For the sake of brevity, conventional data networking, application development, and other functional aspects of the systems (and components of the individual operating components of the systems) are not described in detail herein. Furthermore, the connecting lines shown in the various figures contained herein are intended to represent exemplary functional relationships and/or physical couplings between the various elements. It should be noted that many alternative or additional functional relationships or physical connections can be present in a practical system.

The present system or any part(s) or function(s) thereof can be implemented using hardware, software, or a combination thereof and can be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations can be machine operations. Useful machines for performing the various embodiments include general-purpose digital computers or similar devices.

In fact, in various embodiments, the embodiments are directed toward one or more computer systems capable of carrying out the functionality described herein. The computer system includes one or more processors, such as a processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random-access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage unit in a well-known manner. The removable storage unit represents a floppy disk, magnetic tape, optical disk, etc., which is read by and written to by the removable storage drive. As will be appreciated, the removable storage unit includes a computer-usable storage medium having stored therein computer software and/or data.

In various embodiments, secondary memory can include other similar devices for allowing computer programs or other instructions to be loaded into the computer system. Such devices can include, for example, a removable storage unit and an interface. Examples of such can include a program cartridge and cartridge interface (such as that found in video game devices), a removable memory chip (such as an erasable programmable read-only memory (EPROM), or programmable read-only memory (PROM)), and an associated socket, and other removable storage units and interfaces, which allow software and data to be transferred from the removable storage unit to computer system.

The computer system can also include a communications interface. The communications interface allows software and data to be transferred between the computer system and external devices. Examples of communications interfaces can include a modem, a network interface (such as an Ethernet card), a communications port, a Personal Computer Memory Card International Association (PCMCIA) slot and card, etc. Software and data transferred via communications interface are in the form of signals which can be electronic, electromagnetic, optical, or other signals capable of being received by the communications interface. These signals are provided to the communications interface via a communications path (e.g., channel). This channel carries signals and can be implemented using wire, cable, fiber optics, a telephone line, a cellular link, a radio frequency (RF) link, wireless, and other communications channels.

The terms “computer program medium,” “computer usable medium,” and “computer-readable medium” are used to generally refer to media such as a removable storage drive and a hard disk installed in a hard disk drive. These computer program products provide software to the computer system.

Computer programs (also referred to as computer control logic) are stored in main memory and/or secondary memory. Computer programs can also be received via the communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, the software can be stored in a computer program product and loaded into a computer system using a removable storage drive, hard disk drive, or communications interface. The control logic (software), when executed by the processor, causes the processor to perform the functions of various embodiments as described herein. In various embodiments, hardware components such as application-specific integrated circuits (ASICs). Implementation of the hardware state machine to perform the functions described herein will be apparent to persons skilled in the relevant art(s).

In certain embodiments, a server can include application servers that are operating system agnostic.

A web client includes any device (e.g., personal computer) which communicates via any network, for example, such as those discussed herein. Such browser applications comprise Internet browsing software installed within a computing unit or a system to conduct online transactions and/or communications. These computing units or systems can take the form of a computer or set of computers, although other types of computing units or systems can be used, including laptops, notebooks, tablets, handheld computers, personal digital assistants, set-top boxes, workstations, computer-servers, mainframe computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web client can run MICROSOFT® EDGE®, MOZILLA® FIREFOX®, GOOGLE® CHROMED®, APPLE® Safari, or any other of the myriad software packages available for browsing the internet.

Practitioners will appreciate that a web client can or cannot be in direct contact with an application server. For example, a web client can access the services of an application server through another server and/or hardware component, which can have a direct or indirect connection to an Internet server. For example, a web client can communicate with an application server via a load balancer. In various embodiments, access is through a network or the Internet through a commercially available web browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client can include any suitable personal computer, network computer, workstation, personal digital assistant, cellular phone, smartphone, minicomputer, mainframe, or the like. A web client can be in a home or business environment with access to a network. In various embodiments, access is through a network or the Internet through a commercially available web browser software package. A web client can implement security protocols such as Secure Sockets Layer (SSL) and Transport Layer Security (TLS). A web client can implement several application layer protocols, including HTTP, HTTPS, FTP, and SFTP.

In various embodiments, components, modules, and/or engines of the system can be implemented as micro-applications or micro-apps. Micro-apps are typically deployed in the context of a mobile operating system, including, for example, a WINDOWS® mobile operating system, an ANDROID® Operating System, APPLE® IOS®, a BLACKBERRY® operating system, and the like. The micro-app can be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app can leverage the communication protocol of the operating system and associated device hardware under the predetermined rules of the mobile operating system. Moreover, where the micro-app desires an input from a user, the micro-app can be configured to request a response from the operating system which monitors various hardware components and then communicates a detected input from the hardware to the micro-app.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing can include location-independent computing, whereby shared servers provide resources, software, and data to computers and other devices on demand.

As used herein, “transmit” can include sending electronic data from one system component to another over a network connection. Additionally, as used herein, “data” can include encompassing information such as commands, queries, files, data for storage, and the like in digital or any other form.

Any databases discussed herein can include relational, hierarchical, graphical, or object-oriented structures and/or any other database configurations. Common database products that can be used to implement the databases include DB2 by IBM® (Armonk, N.Y.), various database products available from ORACLE) Corporation (Redwood Shores, Calif.), MICROSOFT® Access® or MICROSOFT® SQL Server, by MICROSOFT® Corporation (Redmond, Wash.), MySQL by MySQL AB (Uppsala, Sweden), or any other suitable database product. Moreover, the databases can be organized in any suitable manner, for example, as data tables or lookup tables. Each record can be a single file, a series of files, a linked series of data fields, or any other data structure. The association of certain data can be accomplished through any desired data association technique, such as those known or practiced in the art. For example, the association can be accomplished either manually or automatically. Automatic association techniques can include, for example, a database search, a database merge, GREP, AGREP, SQL, using a key field in the tables to speed searches, sequential searches through all the tables and files, sorting records in the file according to a known order to simplify lookup, and/or the like. The association step can be accomplished by a database merge function, for example, using a “key field” in pre-selected databases or data sectors. Various database tuning steps are contemplated to optimize database performance. For example, frequently used files such as indexes can be placed on separate file systems to reduce In/Out (“I/O”) bottlenecks.

More particularly, a “key field” partitions the database according to the high-level class of objects defined by the key field. For example, certain types of data can be designated as a key field in a plurality of related data tables, and the data tables can then be linked based on the type of data in the key field. The data corresponding to the key field in each of the linked data tables is preferably the same or of the same type. However, data tables having similar, though not identical, data in the key fields can also be linked by using AGREP, for example. In accordance with one embodiment, any suitable data storage technique can be utilized to store data without a standard format. Data sets can be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by the first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that can include fractal compression methods, image compression methods, etc.

One skilled in the art will also appreciate that, for security reasons, any databases, systems, devices, servers, or other components of the system can consist of any combination thereof at a single location or multiple locations, wherein each database or system includes any of various suitable security features, such as firewalls, access codes, encryption, decryption, compression, decompression, and/or the like.

Any of the communications, inputs, storage, databases, or displays discussed herein can be facilitated through a website having web pages. The term “web page,” as it is used herein, is not meant to limit the type of documents and applications that might be used to interact with the user. For example, a typical website might include, in addition to standard HTML documents, various forms, JAVA®, JAVASCRIPT, active server pages (ASP), common gateway interface scripts (CGI), extensible markup language (XML), dynamic HTML, cascading style sheets (CSS), AJAX (Asynchronous JAVASCRIPT and XML), helper applications, plug-ins, and the like. A server can include a web service that receives a request from a web server, the request including a URL and an IP address (such as 123.56.192.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL, and UDDI. Web services methods are well known in the art and are covered in many standard texts.

Practitioners will also appreciate that there are a number of methods for displaying data within a browser-based document. Data can be represented as standard text or within a fixed list, scrollable list, drop-down list, editable text field, fixed text field, pop-up window, and the like. Likewise, there are a number of methods available for modifying data on a web page, such as, for example, free text entry using a keyboard, a selection of menu items, check boxes, option boxes, and the like.

The system and method can be described herein in terms of functional block components, screenshots, optional selections, and various processing steps. It should be appreciated that such functional blocks can be realized by any number of hardware and/or software components configured to perform the specified functions. For example, the system can employ various integrated circuit components, e.g., memory elements, processing elements, logic elements, look-up tables, and the like, which can carry out a variety of functions under the control of one or more microprocessors or other control devices. Similarly, the software elements of the system can be implemented with any programming or scripting language. The present technology, in various embodiments, can be utilized with the Microsoft® NET Development Stack. In some embodiments, the present invention can use the PyTorch software package in Python to train the machine learning and/or artificial intelligence models. Visual Basic, SQL Stored Procedures, PL/SQL, any UNIX shell script, and extensible markup language (XML) with the various algorithms being implemented with any combination of data structures, objects, processes, routines, or other programming elements. Further, it should be noted that the system can employ any number of conventional techniques for data transmission, signaling, data processing, network control, and the like. Still, further, the system could be used to detect or prevent security issues with a client-side scripting language, such as JAVASCRIPT, VBScript, or the like.

These computer program instructions can be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions can also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flow and the descriptions thereof can refer to user WINDOWS®, webpages, websites, web forms, prompts, etc. Practitioners will appreciate that the illustrated steps described herein can comprise any number of configurations, including the use of WINDOWS®, webpages, web forms, popup WINDOWS®, prompts, and the like. It should be further appreciated that the multiple steps, as illustrated and described, can be combined into single webpages and/or WINDOWS® but have been expanded for the sake of simplicity. In other cases, steps illustrated and described as single process steps can be separated into multiple web pages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems and any elements that can cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone can be present in an embodiment, B alone can be present in an embodiment, C alone can be present in an embodiment, or that any combination of the elements A, B, and C can be present in a single embodiment; for example, A and B, A and C, B and C, or A and B and C.

Although the disclosure includes a method, it is contemplated that it can be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, a device or method does not need to address every problem sought to be solved by the present disclosure, for it to be encompassed by the present claims. Furthermore, no element, component, or method step in the present disclosure is intended to be dedicated to the public, regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications can be made while remaining within the spirit and scope herein.

It is understood that although a number of different embodiments of the systems and methods have been illustrated and described herein, one or more features of any one embodiment can be combined with one or more features of one or more of the other embodiments, provided that such combination satisfies the intent of the present invention.

While a number of exemplary aspects and embodiments of the anonymization system and methods have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope, and no limitations are intended to the details of construction or design herein shown.

What is claimed is:

1. An anonymization system for anonymizing data within an anonymization receiver for use by a first user and a second user, the anonymization system comprising:
a database that is configured to store at least one of (i) a first data that corresponds to the first user, and (ii) a second data that corresponds to the second user; and
an anonymizer that anonymizes at least one of the first data and the second data, the anonymizer being configured to transfer anonymized data to the anonymization receiver.

2. The anonymization system of claim 1 wherein the anonymized data includes an identity of the first user.

3. The anonymization system of claim 2 wherein the anonymized data includes an identity of the second user.

4. The anonymization system of claim 1 wherein the anonymizer is configured to generate an anonymizing identifier that is based on at least one of the first data and the second data.

5. The anonymization system of claim 4 wherein the anonymizer is configured to generate a token that represents the anonymizing identifier.

6. The anonymization system of claim 1 wherein the anonymizer is configured to encrypt at least one of the first data and the second data.

7. The anonymization system of claim 6 wherein the anonymizer is configured to encrypt using an AES algorithm.

8. The anonymization system of claim 6 wherein the anonymizer is configured to store at least one of an encryption key and a decryption key on the database.

9. The anonymization system of claim 1 wherein the anonymizer is configured to de-anonymize the anonymized data.

10. The anonymization system of claim 1 wherein the anonymizer is configured to use artificial intelligence to automatically detect and anonymize the anonymization receiver.

11. A method for anonymizing data within an anonymization receiver for use by a first user and a second user, the method comprising the steps of:
storing at least one of (i) a first data that corresponds to the first user, and (ii) a second data that corresponds to the second user in a database;
anonymizing at least one of the first data and the second data with an anonymizer; and
transferring anonymized data to the anonymization receiver.

12. The method of claim 11 further comprising the step of generating an anonymizing identifier that is based on at least one of the first data and the second data with the anonymizer.

13. The method of claim 12 further comprising the step of generating a token that represents the anonymizing identifier with the anonymizer.

14. The method of claim 11 further comprising the step of hashing at least one of the first data and the second data with the anonymizer.

15. The method of claim 11 further comprising the step of encrypting at least one of the first data and the second data with the anonymizer.

16. The method of claim 15 wherein the step of encrypting is completed using an AES algorithm.

17. The method of claim 15 further comprising the step of storing at least one of an encryption key and a decryption key on the database.

18. The method of claim 11 wherein the anonymizer is configured to de-anonymize the anonymized data.

19. The method of claim 11 wherein the database is configured to allow access to data by users based on a plurality of permission settings.

20. An anonymization system for anonymizing data within an anonymization receiver for use by a first user and a second user, the anonymization system comprising:
a database that is configured to store at least one of (i) a first data that corresponds to the first user, and (ii) a second data that corresponds to the second user; and
an anonymizer that anonymizes at least one of the first data and the second data, the anonymizer being configured to transfer anonymized data to the anonymization receiver, the anonymizer being configured to (i) generate an anonymizing identifier that is based on at least one of the first data and the second data, (ii) generate a token that represents the anonymizing identifier, (iii) encrypt at least one of the first data and the second data, (iv) de-anonymize the anonymized data, (v) use artificial intelligence to automatically detect and anonymize the anonymization receiver.
